(19) United States
(12) Patent Application Publication
(10) Pub. No.: US 2018/0141318 A1
(43) Pub. Date: May 24, 2018

(54) FILM HAVING A WOOD-LIKE APPEARANCE

(71) Applicant: Klöckner Pentaplast GmbH, Heiligenroth (DE)

(72) Inventors: Cédric REUTER, Köln (DE); Adrian FASEL, Guckheim (DE); Sascha JÜRGENS, Eppenrod (DE); Evgeny BELUKHICHEV, St. Petersburg (RU); Christian KOHLERT, Oberahr (DE)

(21) Appl. No.: 15/574,728

(22) PCT Filed: May 27, 2016
(86) PCT No.: PCT/EP2016/000881

§ 371 Date: Nov. 16, 2017

(30) Foreign Application Priority Data
Jun. 3, 2015 (DE) 10 2015 006 878.4

(51) Int. Cl. B32B 27/30; B32B 7/02

(52) U.S. Cl. CPC B32B 27/304; C08F 114/06; B32B 7/02

(57) ABSTRACT

The invention relates to a film having a wood-like appearance and having a width from 0.1 to 6 m, a length of 2 to 10,000 m, a thickness from 180 to 1,000 μm and formed from, a material which contains, relative the total weight thereof 40 to 85 wt % of vinylchloride polymerizate, 10 to 60 wt % of a powder made from vegetable components, 0 to 30 wt % of one or more inorganic filler substances, and 5 to 30 wt % of one or more additives.

The invention relates to a film made of a material composed of, based on its total weight, from 40 to 35% by weight of vinyl chloride polymer, from 10 to 60% by weight of rice-husk powder, peanut-shell powder or a mixture of rice-husk and peanut-shell powder, from 0 to 30% by weight of one or more inorganic fillers and from 5 to 30% by weight of one or more additives.

The invention further relates to a process for the production of a film comprising the steps of
(a) provision of a material composed of, based on its total weight, from 40 to 85% by weight of vinyl chloride polymer, from 10 to 60% by weight of rice-husk powder, peanut-shell powder or a mixture of rice-husk and peanut-shell powder, from 0 to 30% by weight of one or more inorganic fillers and from 5 to 30% by weight of one or more additives;
(b) plastification of the material in a gelling assembly where the material is heated to a temperature of from 160 to 190° C.;
(c) moulding of the material plastified in step (b) to give a film of width from 0.1 to 6 m, length from 2 to 10 000 m and thickness d from 180 to 1000 μm.

The invention moreover comprises items such as bowls, cups and plates which have been thermoformed from a film which lias one layer or has been equipped with a lamination film and which is composed of, based on its total weight, from 40 to 85% by weight of vinyl chloride polymer, from 10 to 60% by weight of rice-husk powder, peanut-shell powder or a mixture of rice-husk and peanut-shell powder, from 0 to 30% by weight of one or more inorganic fillers and from 5 to 30% by weight of one or more additives.

The expression “vinyl chloride polymer” means vinyl chloride homopolymers, vinyl chloride copolymers, and also mixtures of the above polymers. The expression “vinyl chloride polymer” in particular comprises
polyvinyl chlorides (PVC) produced via homopolymerization of vinyl chloride, and
vinyl chloride copolymers which are formed via polymerization of vinyl chloride with one or more comonomers such as ethylene, propylene or vinyl acetate.

The term “film” here and hereinafter comprises separate pieces of a film, and also industrially produced film webs with lengths of from a few hundred metres up to some thousands of metres.

The film of the invention is produced via plastification and then calendering of a composition made of vinyl chloride polymer, rice-husk powder, peanut-shell powder, or a mixture of rice-husk and peanut-shell powder, and various additives—hereinafter termed filler-plastic composite or “FPC”—and can be further processed in-line and/or off-line. The film is in particular suitable for the thermoforming of product packaging of complex shape.

The prior art discloses mouldings made of wood-plastic composite or “WPC”. The known mouldings made of WPC are produced by extrusion and their thickness is ≥1.5 mm. In a few cases, small-format WPC mouldings or sections of WPC extrudates of thickness in the range from 0.8 to 1.5 mm have been prepared for investigation of mechanical properties, for example tensile impact resistance.

In contrast, the prior art has not disclosed any relatively large films made of WPC which, can be used for commercial and industrial applications and having a thickness of ≤1 mm and dimensions of about 1 m up to some thousands of metres,

Accordingly, it is an object of the present invention to provide large-format films which can be used in commercial and industrial applications, based on wood-like filler-plastic composite or FPC.

This object is achieved via a film made of a material composed of, based on its total weight, from 40 to 85% by weight of vinyl chloride polymer, from 10 to 60% by weight of rice-husk powder, peanut-shell powder or a mixture of rice-husk and peanut-shell powder, from 0 to 30% by weight of one or more inorganic fillers and from 5 to 30% by weight of one or more additives, where the width of the film is from 0.1 to 6 m, its length is from 2 to 10 000 m and its thickness is from 180 to 1000 μm.

Advantageous embodiments of the film of the invention are characterised in that:
the thickness of the film is from 180 to 300 μm, from 200 to 400 μm, from 300 to 500 μm, from 400 to 600 μm, from 500 to 700 μm, from 600 to 800 μm, from 700 to 900 μm or from 800 to 1000 μm;
the length of the film is from 10 to 10 000 m or from 100 to 10 000 m;
the arithmetic average roughness value Ra of a first surface of the film is from 3 to 20 μm and preferably from 3 to 10 μm;
the arithmetic average roughness value Ra of a second surface of the film is from 3 to 50 μm and preferably from 3 to 20 μm;
at least one surface of the film has been embossed;
the tensile strength of the film is from 10 to 20 N/mm²;
the tensile impact resistance of the film is from 42 to 50 kJ/m²;
the tensile strain at break of the film is from 1.6 to 2.2%;
the density of the film is from 1.34 to 1.42 g/cm³;
the inorganic fillers are selected from chalk, talc, mica, alumina, kaolin, silicates and titanium oxide;
the additives are selected, from processing aids, heat, stabilizers, lubricants, polymeric modifiers, dyes and pigments, fungicides, UV stabilisers, fire-protection agents and fragrances;
the material comprises, based on its total weight, from 1 to 6% by weight of one or more lubricants selected from waxes, fats, paraffins, epozidized soya oil and acrylate-based polymers;
the material comprises, based on its total weight, from 3 to 12% by weight of one or more polymeric modifiers selected from acrylate-, butyl-methacrylate-, methacrylate-butyl-styrene-, methyl-methacrylate-butadiene-styrene- and chlorinated-polyethylene-based polymers;
the flow exponent n of the material at a temperature of 190° C. is from 0.05 to 0.36;
the particle size of the powder made of rice husks and/or of peanut shells is from 10 to 250 μm;
the powder made of rice husks and/or of peanut shells comprises silane groups with the structural formula I and/or II

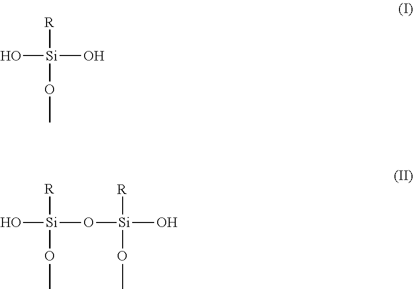

where R is a group selected from NH₂(CH₂)₃ and (CH₃CH₂)₂;
the powder made of rice husks and/or of peanut shells has been acetylated with a weight increase of from S to 25%, based on the weight of the powder before acetylation; and/or
a lamination film has been laminated onto at least one surface of the film, where the lamination film is composed of a material comprising, based on its total weight, from 7 0 to 98% by weight of a polymer selected from polyethylene and polyester.

Another object of the invention is to provide a process for the production of large-format films based on FPC which can be used in commercial and industrial applications.

This object is achieved via a process comprising the steps of
(a) provision of a material composed of, based on its total weight, from 40 to 65% by weight of vinyl chloride polymer, from 10 to 60% by weight of rice-husk powder, peanut-shell powder or a mixture of rice-husk and peanut-shell powder, from 0 to 30% by weight of one or more inorganic fillers and from 5 to 30% by weight of one or more additives;
(b) plastification of the material in a gelling assembly where the material is heated to a temperature of from 160 to 190° C.;
(c) moulding of the material plastified in step (b) to give a film of width from 0.1 to 6 m, length from 2 to 10 000 m and thickness d from 180 to 1000 μm;
   where
the flow exponent n of the material provided in step (a) at a temperature of from 190° C. is from 0.05 to 0.36; and
in step (c) the plastified material is calendered on a roll calender, where the material passes through a shaping nip the surface temperature of the two roils forming the shaping nip, mutually independently, is from 150 to 220° C., the said rolls rotate with a peripheral velocity of from 20 to 80 m/min and the ratio of the peripheral velocities of the two rolls is from 1.0 to 1.2.

Advantageous embodiments of the process of the invention are characterized in that:
the flow exponent n at a temperature of 190° C of the material provided in step (a) is from 0.1 to 0.36 or from 0.15 to 0.36;
the plastified material is calendered in step (c) on a roll calender where the material passes through a shaping nip arid an accumulation of material of height from 5 to 30 mm forms in advance of the nip;
the plastified material is calendered in step (c) on a roll calender where the material passes through a shaping nip and an accumulation of material of height from 5 to 20 mm forms in advance of the nip;
the plastified material is calendered in step (c) on a roll calender where the material passes through a shaping nip and an accumulation of material of height from 10 to 30 mm forms in advance of the nip;
the plastified material is calendered in step (c) on a roll calender where the material passes through a shaping nip and an accumulation of material of height from 10 to 20 mm forms in advance of the nip;
the plastified material is calendered in step (c) on a roll calender where the material passes through a shaping nip of height h, where −0.0299·n²+0.0133·d²−0.02·n·d+0.0262 ·n+0.786·d−0.0042≤h≤0.0258·n²+0.0459·d²−0.0667·n·d+0.0106·n+0.8182·d−0.0053, where n is the flow exponent, at a temperature of 190° C. of the material, d is the thickness of the film, and h and d are stated in the unit mm;
the plastified material is calendered in step (c) on a roll calender where the material passes through a shaping nip of height h, where −0.01.69·n²+0.0175·d²−0.0021·n·d+0.0232·n+0.7316·d−0.0045≤h≤0.028·n²+0.0459·d²−0.667·n·d+0.0106·n+0.8182·d−0.0053, where n is the flow exponent at a temperature of 190° C. of the material, d is the thickness of the film, and h and d are stated, in the unit mm;
the plastified material is calendered in step (c) on a roll calender where the material passes through a shaping nip of height h, where −0.0299·n²≤0.0133·d²−0.02·n·d+0.0262·n+0.786·d−0.0042≤h≤0.007.9·n²+0.028·d²−0.0326·n·d+0.0167·n+0.8037·d−0.0049, where n is the flow exponent at a temperature of 190° C. of the material, d is the thickness of the film, and h and d are stated in the unit mm;
the plastified material is calendered in step (c) on a roll calender where the material passes through a shaping nip of height h, where −0.016·n²+0.0175·d²−0.0021·n·d+0.0232·n+0.7916·d−0.0045≤h≤0.0079·n²+0.028·d²−0.0326·n·d+0.0167·n+0.8037·d−0.0049, where n is the flow exponent at a temperature of 190° C. of the material, d is the thickness of the film, and h and d are stated in the unit mm;
the surface temperatures Ta and Tb of the two rolls forming the shaping nip comply with the relationship 10° C.≤Ta−Tb≤40° C., where Ta is the surface temperature of the first roll in the direction of running of the film and Tb is the surface temperature of the second, roll in the direction of running of the film;
the surface temperatures Ta and Tb of the two rolls forming the shaping nip comply with the relationship 20° C.≤Ta−Tb≤40° C., where Ta is the surface temperature of the first roll in the direction of running of the film and Tb is the surface temperature of the second roll in the direction of running of the film;
the surface temperatures Ta and Tb of the two rolls forming the shaping nip comply with the relationship 30° C.≤Ta−Tb≤40° C., where Ta is the surface temperature of the first roll in the direction of running of the film and Tb is the surface temperature of the second roll in the direction of running of the film;
the surface temperature of the two rolls forming the shaping nip mutually independently is from 150 to 200° C. or from 170 to 220° C.;
the film moulded in step (c) is drawn off from the roll calender by means of one or more take-off rolls, where the peripheral velocity of a take-off roll that is first in the direction of running of the film is from 1.005 times to 1.1 times the peripheral velocity of the shaping-nip roll that is second in the direction of running of the film;
the film moulded in step (c) is drawn off from the roll calender by means of one or more take-off rolls, where the peripheral velocity of a take-off roil that is first in the direction of running of the film is from 1.005 times to 1.05 times the peripheral velocity of the shaping-nip roll that is second in the direction of running of the film;
the film moulded in step (c) is drawn off from the roll calender by means of two or more take-off rolls, where the peripheral velocity of a take-off roll that is first in the direction of running of the film is from 1.005 times to 1.1 times the peripheral velocity of a take-off roll that is downstream in the direction of running of the film;
the film moulded in step (c) is drawn off from the roll calender by means of two or more take-off rolls, where the peripheral velocity of a take-off roll that is first in the direction of running of the film is from 1.005 times to 1.05 times the peripheral velocity of a take-off roll that is downstream in the direction of running of the film;
the peripheral velocity at which the two rolls forming the shaping nip rotate mutually independently is from 3 0to 38 m/min, from 36 to 44 m/min or from 42 to 50 m/min;
the ratio of the peripheral velocities of the two rolls forming the shaping nip is from 1.0 to 1.05, from 1.025to 1.075, from 1.05 to 1.1, from 1.075 to 1.125, from 1.1 to 1.15, from 1.125 to 1.175 or from 1.15 to 1.2;
the roll calender comprises one or more embossing roils and at least one surface of the film moulded in step (c) is embossed by means of the embossing roll; and/or
a lamination film is laminated onto a surface of the film moulded in step (c), where the lamination film is composed of a material comprising, based on its total weight, from 70 to 98% by weight of a polymer selected from polyethylene and polyester.

All weight data are based on the total weight of the FPC material of the invention, where the total weight of the FPC material corresponds to 100% by weight. The total weight of the FPC material is ascertained by calculating the sum of the weights of ail the components present in the FPC material, for example PVC and rice powder. Accordingly, the sum of the proportions by weight of all of the components present in the FPC material is always 100% by weight, irrespective of the lower and upper limits provided for the purposes of the invention for the proportions by weight of individual components. The proportions by weight of individual components are selected within the respective lower and upper limits in such a way that the sum of the proportions by weight, of all of the components present in the FPC material always corresponds to 100% by weight.

Quantities of from 5 to more than 50% by weight, based on the total weight of the FPC material, of vinyl chloride copolymers are optionally used to improve the flowability and thermoformability of the FPC material of the invention and of the film produced, therefrom.

The proportions by weight of individual additives selected from processing aids, heat stabilizers, lubricants, polymeric modifiers, colour pigments, fungicides and fragrances are, as required, from 0.1 to 30% by weight. Quantities of from 1 to 20% by weight, based on the total weight of the FPC material, of polymers made of acrylonitrile-butadiene-styrene, methyl methacrylate-butadiene-styrene, methyl methacrylate-acrylonitrile-butadiene-styrene, methyl methacrylate, chlorinated polyethylene, polymethyl methacrylate and ethylene-vinyl acetate are used as polymeric modifier additives to increase tensile impact resistance. The FPC material of the invention moreover comprises conventional lubricants such as fatty acids, fatty alcohols, fatty acid amides, metal soaps, natural or synthetic waxes, esters of fatty acids with mono- or polyhydric alcohols, esters of dicarboxylic acids with mono- or polyhydric alcohols, esters of fatty acids and dicarboxylic acids with polyhydric alcohols, the materials known as mixed esters or complex esters, or esters of phthalic acid with mono- or polyhydric alcohols. The quantity of lubricants is from 0.1 to 6% by weight, based on the total weight of the FPC material. Materials provided as heat stabilizers are organotin stabilisers, in particular tin carboxylates, tin mercaptides, tetramethyltin and tin thioglycolates. Other materials used are metal stabilizers based on calcium or zinc, and other metal-free organic stabilizers and inorganic stabilizers, for example dihydrotalcite-based chlorine scavengers. The proportion of heat stabilisers is generally from 0.3 to 5% by weight, based on the total weight of the FPC material.

The FPC material of the invention comprises, based on its total weight, from 10 to 30% by weight, from 20 to 40% by weight, from 30 to 50% by weight or from 40 to 60% by weight, of a powder made of rice husks and/or of peanut shells. For the purposes of the present invention, the term “powder” means a material which takes the form of flowable powder or takes the form of agglomerates or particles dispersed in a matrix. In a manner according to the invention, the equivalent diameter of the powder grains or dispersed particles or agglomerates is in the range from 10 to 250 μm, from 10 to 130 μm, 70 to 190 μm, from 130 to 250 μm, from 10 to 70 μm, from 40 to 100 μm, from 7 0 to 130 μm, from 100 to 160 μm from 130 to 190 μm, from 160 to 220 μm or from 190 to 250 μm.

The expression “equivalent diameter” means the diameter of a spherical particle which has the same material composition and which, in accordance with the measurement method used, has the same projection area (electron microscope) as, or exhibits the same light scattering as, the particle in question.

In an advantageous embodiment of the process of the invention, the surface temperature of the second of the rolls forming the shaping nip is comparatively low, in the range from 150 to 160° C. This type of low surface temperature reduces the force or tensile stress required for the release of the film from the second roll of the shaping nip.

For the release or removal of the film from the roll calender it is preferable to use a take-off device with one, two or more take-off rolls, where a first take-off roll rotates with a peripheral velocity that is from 0.5 to 10% higher than the peripheral velocity of the second roll of the shaping nip. Accordingly, as the film proceeds from the roll calender to the take-off device its dimension is increased in the direction of running by from 0.5 to 10%.

In a particularly advantageous embodiment of the process of the invention, a first take-off roll rotates with a peripheral velocity that is from 0.5 to 10% higher than the peripheral velocity of a downstream, take-off roll. Accordingly, as the film proceeds from the first take-off roll to the downstream take-off roll its dimension is reduced in the direction of running by from 0.5 to 10%.

The invention is explained in more detail below with reference to Figures and Examples.

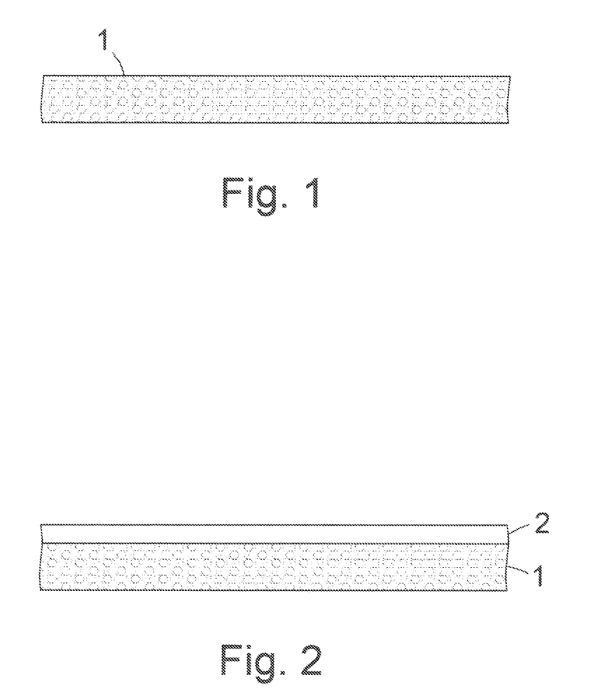

FIGS. 1 and 2 are sectional views of a single- and two-layer film of the invention;

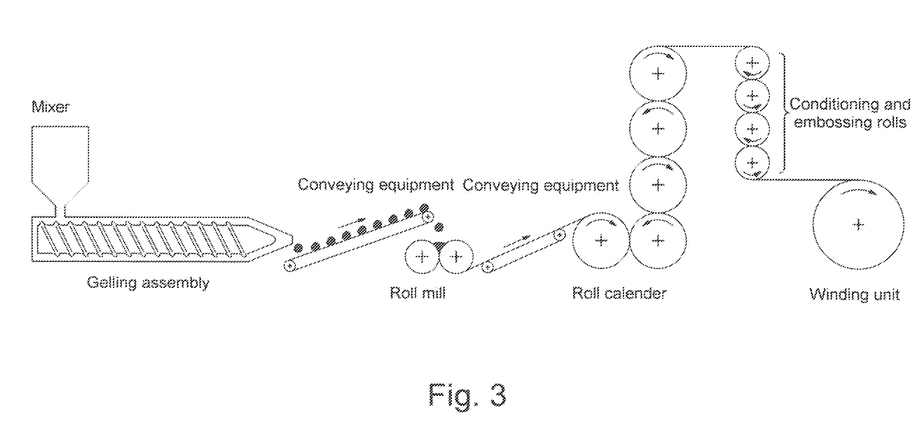

FIG. 3 is a block diagram of a calender device for the production of a single-layer film;

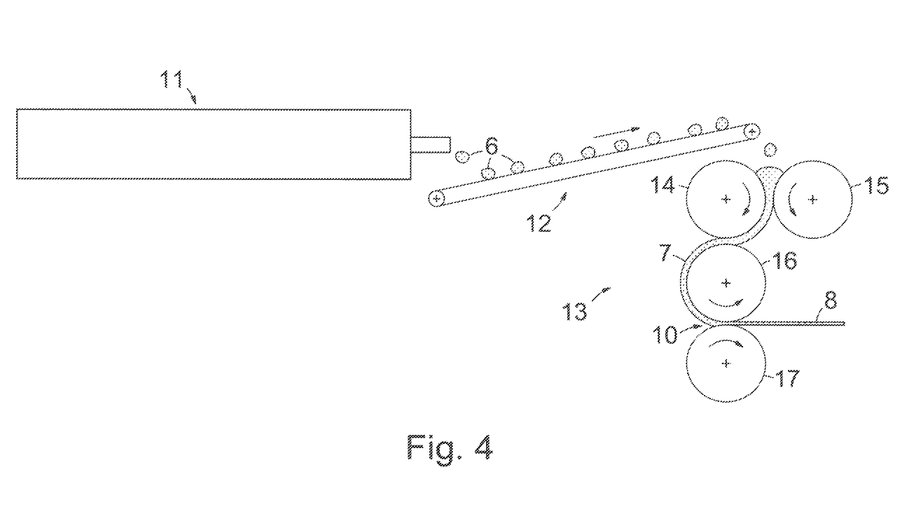

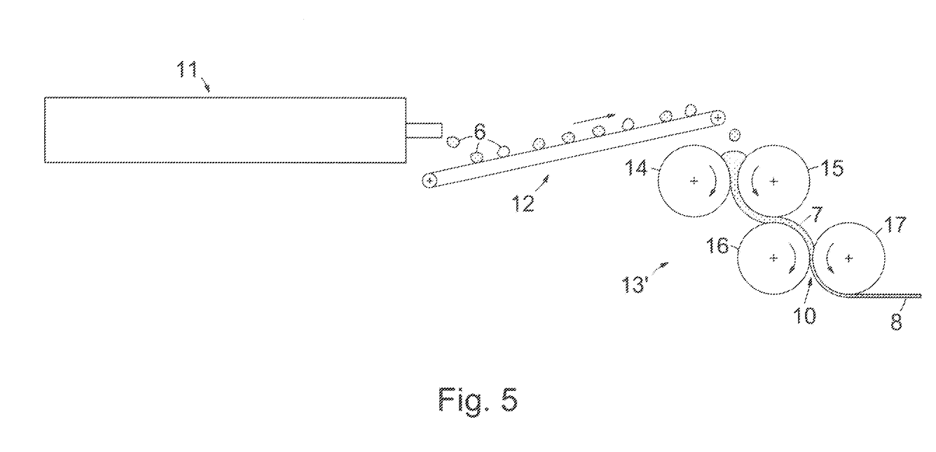

FIGS. 4 and 5 are diagrams of parts of calender devices; and

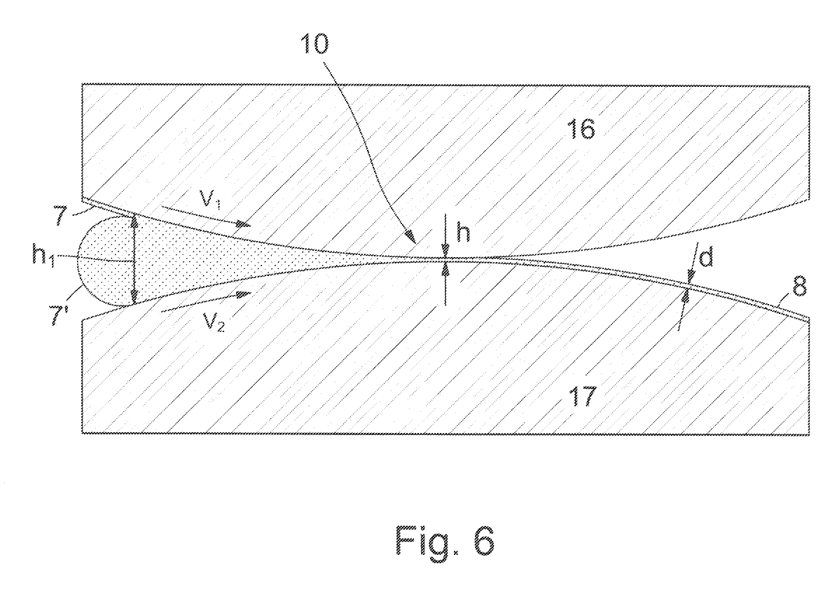

FIG. 6 is a sectional view of a shaping nip of a calender device.

FIGS. 1 and 2 are diagrammatic sectional views of a single-layer film 1 of the invention made of FPC material and respectively, a film 1 made of FPC material coated with a lamination film 2. The lamination film 2 is composed of a material that comprises, based on its total weight, from 70to 98% by weight of a polymer selected from polyethylene and polyester.

FIG. 3 is a diagram of a calender device conventionally used in industry with a gelling assembly, a roll calender, conditioning and optionally embossing rolls, and also a winding unit. An FPC material in the form of powder or of granules is introduced by way of an associated mixer into the gelling assembly. According to the invention, the composition of the FPC material introduced into the gelling assembly is precisely controlled in order to ensure that the rheological properties of the plastified material are substantially constant, and that any variations are within a narrow tolerance range. Production of the film of the invention can use any desired calender devices with configuration differing from FIG. 3, as explained, below in connection with FIGS. 4 and 5. In particular, calender devices comprising one or two lamination units are envisaged.

FIG. 4 is a simplified view of part of a calender device with a gelling assembly 11 for the plastification of the FPC material of the invention, conveying equipment 12 and a roll calender 13. An extruder or kneader is envisaged as gelling assembly 11. Suitable extruders and kneaders known to the person skilled in the art can be purchased from various manufacturers. The FPC material 6 plastified in the gelling assembly 11 is transferred by means of the conveying equipment 12 onto the roll calender 13 and moulded to give a film 8. The FPC material located in the roll calender 13 is indicated, by the numeral 7 in FIG. 4. The roll calender 13 comprises from two to eight, preferably four, calender rolls (14, 15, 16, 17), and also one or more embossing and cooling rolls not shown in FIG. 4. The calender device has optionally been equipped with one or more lamination units not shown in FIG. 4. The calender device moreover comprises a winding unit not shown in FIG. 4. The arrangement of the four calender rolls (14, 15, 16, 17) of the roil calender 13 shown in FIG. 4 is termed “inverted L configuration”. The axes of the calender rolls (14, 15, 16, 17) are in essence parallel to one another. The calender rolls (14, 15, 16, 17) are driven and rotate around their longitudinal axes, the direction of rotation of each of two adjacent rolls 14 and 15, 14 and 16 and 16 and 17 being mutually opposed.

Each of the calender rolls 14, 15, 16 and 17 has an associated temperature-control device, and can be cooled or heated independently of the other calender rolls. The temperature of the calender rolls (14, 15, 16, 17) is controlled by means of a fluid, in particular by means of water or oil. The temperature-controlled fluid is introduced to, and removed from, each of the calender rolls 14, 15, 16 and 17 by way of passages within the bearing axis.

In the roll calender 13, the plastified FPC material 7 passes through one or more nips delimited by the curved surface of adjacent rolls 14 and 15, 14 and 16 and 16 and 17. The thickness of the film 8 moulded from the FPC material is determined via the narrowest nip 10, known as the “shaping” nip. The shaping nip 10 is preferably formed by the two final calender rolls (16, 17) of the roll calender 13. The diameters of the calender rolls 16 and 17 which form the shaping nip 10 are from 400 to 900 mm.

The position of the rotary bearings of one or more of the calender rolls (14, 15, 16, 17), in particular of the calender rolls 17 and/or 16 forming the shaping nip 10, can be adjusted with the aid of hydraulic or electrical actuators with an accuracy of a few micrometres. The size of the shaping nip 10 can therefore be adjusted precisely to the technical requirements of the process. The expression “shaping nip height” is conventional in the art and is used hereinafter for the size of the shaping nip.

FIG. 5 is a view of part of a calender device which differs from the device shown in FIG. 4 only in the configuration of the roll calender 13′. The meaning of the other reference signs in FIG. 5 is the same as described above in connection with FIG. 4. The configuration of the roll calender 13′ shown in FIG. 5 is termed “Z configuration” by persons skilled in the art.

For the purposes of the invention, alternative configurations with from two to eight, preferably four, calender roils by way of example in I configuration. S configuration or L configuration are envisaged alongside the roll calenders 13 (inverted L configuration) and 13′ (Z configuration) shown in FIGS. 4 and 5.

The properties of the film of the invention made of FPC material are determined practically exclusively via the operating parameters of the two calender roils that form the shaping nip.

FIG. 6 is a diagrammatic sectional view of a shaping nip 10 formed by two calender rolls 16 and 17. The curved surfaces of the calender rolls 16 and 17, rotating in opposite directions, delimit the nip 10, and the reference sign “h” here indicates the minimal distance between the curved surfaces of the calender rolls 16 and 17 or the shaping nip height. The rotary bearings, not shown in FIG. 6, of the calender rolls 16 and/or 17 can be moved in one or two spatial directions, for example vertically and/or horizontally, over a positioning range of a few millimetres with an accuracy of a few micrometres. It is accordingly possible to achieve precise adjustment of the shaping nip height h. The reference signs “v₁” and, respectively, “v₂” indicate the peripheral velocities of the calender rolls 16 and 17, where the peripheral velocity of the calender roll 17 is greater than or equal to the peripheral velocity of the calender roll 16, i.e. v₁≤v₂.

FIG. 6 moreover depicts the plastified FPC material 7 introduced into the shaping nip 10 and the film 8 moulded therefrom with thickness “d”. The thickness d and the width b of the film 8 depend on the quantity or mass of plastified FPC material 7 introduced per unit of time into the nip 10, and on the peripheral velocities v₁ and v₂ of the calender rolls 16 and, respectively, 17. By virtue of conservation of mass, the mass of film 8 produced per unit of time is the same as the mass of plastified FPC material 7 introduced per unit of time. It is preferable that the plastified FPC material 7 is introduced into the shaping nip 10 in the form of a web with thickness d₁ and width b₁. By virtue of conservation of mass, the relationship v₁×d₁×b₁=v₂×d×b then holds. The ratio of the width b of the film 8 to the width b₁ of the web made of plastified FPC material 7 introduced into the nip is preferably in the range 1.0·b₁≤b<1.2·b₁ and is particularly preferably in the range 1.0·b₁≤b≤1.1·b₁, i.e. the extent to which the web made of plastified FPC material 7 introduced into the shaping nip 10 is widened is up to 20% and, respectively, up to 10%. The length of the film 8 produced per unit of time corresponds to the peripheral velocity v₂, and is also termed production velocity. The height h of the shaping nip 10 is adjusted as a function of the selected thickness d of the film 8 in such a way as to comply with the relationship h≤d.

The diagram in FIG. 6 moreover shows the accumulation of material 7′ which forms in advance of the shaping nip 10 in relation to the direction of conveying of the plastified FPC material 7. The term bank is also used by persons skilled in the art for the accumulation 7′ of material in advance of the nip. The accumulation 7′ of material in advance of the nip arises because some of the FPC material 7 introduced is deflected before the shaping nip 10 and passes through one or more zones of turbulence before being transported by the curved surface of the calender roll 17 through the shaping nip 10. The volume of the accumulation 7′ of material in advance of the nip is determined to a decisive extent by the height h of the shaping nip 10. The volume of the accumulation of material 7′ increases with decreasing height h of the shaping nip 10 and vice versa. The shaping nip 10 can be regarded as retarding the plastified FPC material 7, the extent of the said retardation increasing with decreasing height h. The volume of the accumulation 7′ of material in advance of the nip is minimal for h=d. The height of the accumulation 7′ of material in advance of the nip, or of the bank 7′, is indicated in FIG. 6 by the reference sign “h₁”.

The peripheral velocities v₁ and v₂ and the temperatures of the shaping calender rolls 16 and 17, and also the height h of the nip 10, are of decisive importance for the properties of a film 8 with thickness d produced from FPC material of the invention. It is necessary here to balance the above calender parameters with the rheological properties of the respective FPC material used, in particular the flow exponent n thereof. In principle, the diameter of the shaping calender rolls 16 and 17 also influences the properties of the resultant film 8. However, for the calender rolls envisaged for the purposes of the present invention with diameter conventional in industry in the range from 400 to 900 mm, the influence of the roll diameters is negligible.

For the purposes of the present invention, the expressions “first roll” or “upstream roll” and, respectively, “second roll” or “downstream roll” indicate the arrangement of the relevant roll relative to another roll in relation to the direction of running of the film in the calender device. By way of example, with reference to FIGS. 4, 5 and 5 the two rolls 16 and 17 forming the shaping nip 10 are termed “first” roll 16 and, respectively, “second” roll 17. Analogous considerations apply to a take-off device envisaged according to the invention with two or more take-off rolls, where the expressions “first take-off roll” or “upstream take-off roll” and, respectively, “second take-off roll” or “downstream take-off roll” indicate the arrangement of the relevant take-off roll relative to another take-off roil in relation to the direction of running of the film in the calender device.

The test methods used to characterize the FPC material of the invention and the films produced therefrom are described below.

The tensile strength and tensile strain at break of the films are determined in accordance with DIN EN ISO 527:2012, tensile impact resistance is determined in accordance with DIN EN ISO 8256:2005, density is determined in accordance with DIN EN ISO 1183:2005 and thickness is determined in accordance with DIN 53370:2006.

The flow exponent n of the FPC material is determined in accordance with DIN EN ISO 1133 at a temperature of 190° C. with use of a standard nozzle with diameter 2.035 mm and length 8 mm. Five tests are carried out with applied weights of 2.16 kg, 5.0 kg, 10.0 kg, 15.0 kg and 21.6 kg, corresponding to shear stresses τ of 1.965×10⁴ Pa, 4.548×10⁴ Pa, 9.096×10⁴ Pa, 1.364×10⁵ Pa and 1.965×10⁵ Pa, and the respective melt volume flow rate Q is determined. The associated (apparent) shear velocity is calculated on the basis of the melt volume flow rate Q in accordance with the relationship

$${γ}_{a} = \begin{matrix}4 Q \\ π {R}^{3}\end{matrix}$$

where R=1.0475 mm. Accordingly, \dot{γ} ₐ=1.108 ·Qmm⁻³.

The viscosity η=τ/\dot{γ} ₐ is calculated from the shear velocity \dot{γ} ₐ and the associated shear stress τ. In accordance with the Ostwald-de Waele power law, the following relationship links viscosity τ to shear velocity \dot{γ} ₐ:

η=K·\dot{γ} ₐⁿ⁻¹

where K is the flow consistency index and n is the flow exponent. When both sides of this equation are presented as logarithms, a linear relationship is obtained:

log(η)=log(K)+(n−1)·log(\dot{γ} ₐ)

and this permits determination, via linear regression, of the flow consistency index K and the flow exponent n on the basis of the test results for the melt volume flow rates with the abovementioned five applied weights and, respectively, shear stresses.

The arithmetic average roughness value Ra of the surfaces of the film of the invention is determined by means of a tactile profilometer, for example with a “Hommel-Etamic W20” instrument from Jenoptik. The test is carried out in accordance with the standards DIN EN ISO 4287:2010and DIN EN ISO 16010:2013. The radius of the sensor tip used here is less than 5 μm. The total traversed distance Lt=5×lr for each roughness test, inclusive of pre- and post-traverse distance, is greater than 15 mm. The value used as limiting wavelength λ_{c} for the low-pass filter used to separate roughness and corrugation in accordance with DIN EN ISO 16610:2013 is λ_{c}=2.5 mm; the length of the five individual traverses lr is accordingly lr=2.5 mm (lr=λ_{c}).

According to the invention, the dimensions of microscale particles or agglomerates are determined by using a scanning electron microscope or transmission electron microscope and image analysis software, for example ImageJ (http://imagej.nih.gov/ij). Digitalized electron micrographs are used here for digital measurement, of at least 100, preferably at least 1000, particles or agglomerates with the aid of the image analysis software. Owing to the high lateral resolution of electron microscopes of the prior art, which is in the range from a few angstroms up to 10 nm, depending on the setting of the electron optics and of the parameters of the beam, it is possible to determine the equivalent diameter of the particles or agglomerates with high reliability. Alternatively or in addition, the dimensions of microscope particles or agglomerates are measured by means of light scattering. Test, equipment, suitable for this purpose for particle sizes from 0.01 to 5000 μm is available for purchase inter alia from Horiba Ltd, (Kyoto, Japan) as product LA-300.

1. Film made of a material composed of, based on its total weight, from 40 to 85% by weight of vinyl chloride polymer, from 10 to 60% by weight of rice-husk powder, peanut-shell powder or a mixture of rice-husk and peanut-shell powder, from 0 to 30% by weight of one or more inorganic fillers and from 5 to 30% by weight of one or more additives, wherein the width of the film is from 0.1 to 6 m, its length is from 2 to 10 000 m and its thickness is from 180 to 1000 μm.

2. Film according to claim 1, wherein the length of the film is from 10 to 10 000 m or from 100 to 10 000 m.

3. Film according to claim 1, wherein the arithmetic average roughness value Ra of a first surface of the film is from 3 to 20 μm.

4. Film according to claim 1, wherein the arithmetic average roughness value Ra of a second surface of the film is from 3 to 50 μm.

5. Film according to claim 1, wherein at least one surface of the film has been embossed.

6. Film according to claim 1, wherein the inorganic fillers are selected from chalk, talc, mica, alumina, kaolin, silicates and titanium oxide.

7. Film according to claim 1, wherein the additives are selected from processing aids, heat stabilizers, lubricants, polymeric modifiers, dyes, pigments, fungicides, UV stabilizers, fire-protection agents and fragrances.

8. Film according to claim 1, wherein the material comprises, based on its total weight, from 1 to 6% by weight of one or more lubricants selected from waxes, fats, paraffins, epoxidized soya oil and acrylate-based polymers.

9. Film according to claim 1, wherein the material comprises, based on its total weight from 3 to 12% by weight of one or more polymeric modifiers selected from acrylate-, butyl-methacrylate-, methacrylate-butyl-styrene-, methyl-methacrylate-butadiene-styrene- and chlorinated-polyethylene-based polymers.

10. Film according to claim 1, wherein the flow exponent n of the material at a temperature of 190° C. is from 0.05 to 0.36.

11. Film according to claim 1, wherein the particle size of the powder made of rice husks and/or of peanut shells is from 10 to 250 μm.

12. Film according to claim 1, wherein the powder made of rice husks and/or of peanut shells comprises silane groups with the structural formula I and/or II 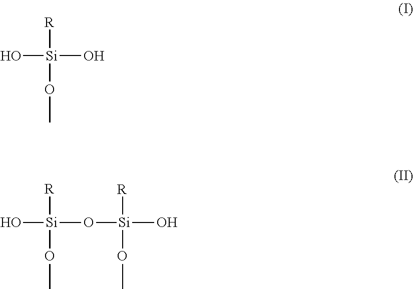
where R is a group selected from NH₂(CH₂)₃ and (CH₃CH₂)₂.

13. Film according to claim 1, wherein the powder made of rice husks and/or of peanut shells has been acetylated with a weight increase of from 9 to 25%, based on the weight of the powder before acetylation.

14. Film according to claim 1, wherein a lamination film has been laminated onto at least one surface of the film, where the lamination film is composed of a material comprising, based on its total weight, from 70 to 98% by weight of a polymer selected from polyethylene and polyester.

15. Process for the production of a film comprising the steps of
(a) providing a material composed of based on its total weight, from 40 to 85% by weight of vinyl chloride polymer, from 10 to 60% by weight of rice-husk powder, peanut-shell powder or a mixture of rice-husk and peanut-shell powder, from 0 to 30% by weight of one or more inorganic fillers and from 5 to 30% by weight of one or more additives;
(b) plasticizing the material in a gelling assembly where the material is heated to a temperature of from 160 to 190° C.;
(c) moulding the material plastified in step (b) to give a Him of width from 0.1 to 6 m, length from 2 to 10 000 m and thickness from 180 to 1000 μm;
wherein
the material provided in step (a) at a temperature of from 190° C. has a flow exponent, n from 0.05 to 0.36; and
step (c) further comprises calendering the plastified material on a roll calender, where the material passes through a shaping nip and forms an accumulation of material of height from 5 to 30 mm in advance of the nip the surface temperature of the two rolls forming the shaping nip, mutually independently, is from 150 to 220° C. the rolls rotate with a peripheral velocity of from 20 to 80 m/min and the ratio of the peripheral velocities of the two rolls is from 1.0 to 1.2.

16. Process for the production of a film according to claim 15, wherein the plastified material is calendered in step (c) on a roll calender where the material passes through a shaping nip and forms a bank of height from 5 to 20 mm.

17. Process for the production of a film according to claim 15, wherein the surface temperatures Ta and Tb of the two rolls forming the shaping nip comply with the relationship 10° C.≤Ta−Tb≤40° C., where Ta is the surface temperature of the first roll in the direction of running of the film and Th is the surface temperature of the second roll in the direction of running of the film.

18. Process for the production of a film according to claim 15, wherein the process further comprises drawing off the film moulded in step (c) from the roll calender by means of one, two or more take-off rolls, where the peripheral velocity of a take-off roll that is first in the direction of running of the film is from 1.005 times to 1.1 times the peripheral velocity of the shaping-nip roll that is second in the direction of running of the film.

19. Process for the production of a film according to claim 15, wherein the process further comprises drawing off the film moulded in step (c) from the roll calender by means of two or more take-off rolls, where the peripheral velocity of a take-off roll that is first in the direction of running of the film is from 1.005 times to 1.1 times the peripheral velocity of a take-off roll that is downstream in the direction of running of the film.

20. Process for the production of a film according to claim 15, wherein the roll calender comprises one or more embossing rolls and at least one surface of the film moulded in step (c) is embossed by means of the embossing roll.

21. Process for the production of a film according to claim 15, wherein said process further comprises laminating a lamination film onto a surface of the firm moulded in step (c), where the lamination film is composed of a material comprising, based on its total weight, from 70 to 98% by weight of a polymer selected from polyethylene and polyester.
